(19) United States
(12) Patent Application Publication
(10) Pub. No.: US 2018/0046943 A1
(43) Pub. Date: Feb. 15, 2018

(54) WAIT-EXPECTANCY SYSTEM AND METHOD

(71) Applicant: ERIN SYBIL GAUTHIER, GRAVENHURST (CA)

(72) Inventor: ERIN SYBIL GAUTHIER, GRAVENHURST (CA)

(21) Appl. No.: 15/234,816

(22) Filed: Aug. 11, 2016

(51) Int. Cl. G06Q 10/02; H04L 29/08

(52) U.S. Cl. CPC G06Q 10/02; H04L 67/10

(57) ABSTRACT

A wait expectancy system including a wait-expectancy assembly and receiving-device. The wait-expectancy assembly including one or more sensors removably installed upon a surface (e.g., seating, flooring, etc), with the receiving-device in communication with the sensors. The sensors transmit the patron-data to the receiving-device. Sensors include one or more, or a combination of: pressure-sensors to detect pressure upon a surface by one or more of the patrons, infrared-sensors to detect a heat-signature provided by one or more of the patrons, and/or audio-sensors to confirm a presence of one or more of said patrons by sound. The wait-expectancy system is structured and arranged to provide the user with an indication of the number of patrons present within the establishment such that the user may postulate/evaluate a wait time for customer-service within the establishment such that the user may determine whether she/he prefers to visit the establishment at a current or future time.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of queue handling and more specifically relates to a wait-expectancy system.

### 2. DESCRIPTION OF RELATED ART

Generally, most places that have unreserved customer/patrons utilize the queue system. Such places can include restaurants, barber shops, motor vehicle offices, as well as many others. A queue is usually a line or similar waiting method where the customer may wait behind another customer based upon the time of arrival of the specific customer. This may often times be referred to as “first-in, first-out” system.

In times when there is a heavy customer/patron load, the wait time may be significant causing distress and frustration to the patron. Also, some patrons/customers may travel or commute to a specific establishment in order to gain services and/or goods from the establishment.

Some businesses and establishments allow for patrons to place “reservations” in order to preserve his/her place in line (aside from the queue), or at a particular time, without being present at the particular establishment during the placing of the reservation. This system may be beneficial in some instances; however, often patrons will not be present at the particular time causing delays to patrons already in the queue. Also, patrons that do not place reservations often would like to have an indication of how many patrons are present at an establishment in order to make the decision whether or not he/she would like to visit the establishment at any given time or date. Therefore a suitable solution is desired.

Several attempts have been made to solve the above-mentioned problems such as those found in U.S. and Foreign Patent and Publication Nos. U.S. Pat. No. 5,502,806 to Mahoney et al; U.S. Pat. No. 5,953,055 to Huang et al; US 5,978,770 to Waytena et al; U.S. Pat. No. 7,046,790 to Holmen; U.S. Pat. No. 8,306,568 to Snyder; U.S. 2008/0133283 to Backer et al; U.S. 2010/0317377 to Zou et al; U.S. 2014/0096140 to Aquino et al; U.S. 2014/0372132 to Tardio; U.S. 2015/0186957 to Barr et al; U.S. 2016/0162844 to Rachuri et al; CA 2,838,074 to Backer et al.; and WO 2015/148695 to Backer. This art is representative of queue handling. However, none of the above inventions and patents, taken either singly or in combination, is seen to describe the invention as claimed.

### BRIEF SUMMARY OF THE INVENTION

In view of the foregoing disadvantages inherent in the known queue handling art, the present invention provides a novel wait-expectancy system. The general purpose of the present invention, which will be described subsequently in greater detail is to provide a system to provide a user with an indication of the number of patrons located within an establishment such that the user may personally evaluate whether she/he would like to visit the establishment to procure goods and/or services based upon the number of patrons (and therefore a probably wait time for the goods and/or services).

A wait expectancy system is disclosed herein, in a preferred embodiment, including a wait-expectancy assembly and a receiving-device. In the preferred embodiment, the wait-expectancy assembly includes plurality of sensors removably installed upon at least one surface, with the receiving-device in communication with the plurality of sensors.

The plurality of sensors, in the preferred embodiment may transmit the patron-data related to the indication of a number of patrons to the receiving-device. The patron-data may be presented to the user such that the user may view and evaluate the patron-data. The at least one surface upon which the plurality of sensors is installed preferably includes at least one of a floor and a plurality of seating-devices (e.g., chairs, benches, couches, booths, etc.).

In the preferred embodiment, the plurality of sensors include one or more, or a combination of: pressure-sensors to detect pressure upon the surface by one or more of the patrons, infrared-sensors to detect a heat-signature provided by one or more of the patrons, and/or audio-sensors to confirm a presence of one or more of said patrons by sound. Other sensing means may be used.

In the preferred embodiment, the receiving-device may include a local-host-server and the local-host-server may also be connectable to a remote-internet-server. Also, the patron-data may be viewable by an employee of the establishment upon the local-host-server, with the employee of the establishment located within the establishment during viewing of the patron-data.

Preferably, the sensors are structured and arranged to provide patron-data, with the patron-data including an indication of a number of individuals present within an establishment. The plurality of sensors may transmit the patron-data to a cloud-based-server to record and store the patron-data for future use. The future use may include the generation of statistics related to the patron-date (e.g., peak demands, shortest wait times, etc.).

In the preferred embodiment, the wait expectancy system also includes a mobile application (mobile-app) executable upon a mobile-device. The mobile-app may provide the patron-data to the mobile-device accessible by the user. Also, the mobile-app may provide alerts to the mobile-device, and therefore the user, based on a predetermined number of the patrons present at the establishment. Preferably, the mobile-app further includes a map-module such that the user may view a location of the establishment in a map-view; and the map of the mobile-app may provide a visual indication of number of patrons; the number of patrons viewable upon the mobile-device related to the location of the establishment on the map-module.

The wait-expectancy system is configured to provide the user with an indication of the number of patrons present within the establishment such that the user may postulate/evaluate a wait time for customer-service within the establishment such that the user may determine whether she/he prefers to visit the establishment at a current or future time.

In embodiments, a kit is also disclosed herein. The kit preferably includes a wait-expectancy assembly (with the wait-expectancy assembly preferably comprising a plurality of sensors removably installed upon one or more surface, a receiving-device in communication with the plurality of sensors), and a mobile-app in communication with the receiving-device.

According to an embodiment, a method for using a wait-expectancy system is also disclosed herein. The method for using a wait-expectancy system preferably includes the steps of: step one, providing a wait-expectancy system (preferably comprising a wait-expectancy assembly, the wait-expectancy assembly preferably comprising a plurality of sensors removably installed upon one or more surfaces, and a receiving-device); step two, placing the plurality of sensors upon the one or more surfaces to provide patron-data to a receiving-device; step three, receiving the patron-data upon the receiving-device; step four, transmitting the patron-data to a user; step five, viewing the patron-data; and step six, alerting the user based upon a predetermined condition of the patron-data.

The present invention holds significant improvements and serves as a wait expectancy system. Preferably, queue handling should provide a user with a real-time indication of the number of patrons located within an establishment by the use of sensors to detect the presence of patrons, such that the user may estimate a probable wait time at the establishment in order to determine if, and/or when, the user should visit the establishment to reduce personal waiting and, yet would operate reliably and be manufactured at a modest expense. Thus, a need exists for a reliable wait-expectancy system to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, a wait-expectancy system, constructed and operative according to the teachings of the present disclosure.

FIG. 1 shows a perspective view illustrating a wait-expectancy system during an ‘in-use’ condition according to an embodiment of the disclosure.

FIG. 2 is a perspective view illustrating a component of the wait-expectancy assembly comprising a sensor removably affixed to a seating-device according to an embodiment of the present invention of the disclosure.

FIGS. 3A is a perspective view illustrating a floor to which a sensor of a wait-expectancy assembly is removably affixed according to an embodiment of the present disclosure.

FIGS. 3B is a section view of FIG. 3A illustrating sensors of a wait-expectancy assembly removably affixed to the floor according to an embodiment of the present disclosure.

FIG. 4 is a flow chart illustrating transmission of patron-data according to an embodiment of the present disclosure.

FIG. 5 is a flow diagram illustrating a method of use for the wait-expectancy system according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to queue handling and more particularly to a wait-expectancy system as used to improve the use efficiency of establishments and minimize the overall wait time of patrons to an establishment.

Generally speaking, a wait-expectancy system includes sensors installed into flooring or chairs at busy establishments, with the sensors connected to a mobile-app. The wait-expectancy system may reduce the need to wait in busy lines at establishments (e.g., Passport offices, barber shops, hospital waiting rooms, vehicle registration locations/drivers license locations, restaurants, etc.). A user of the wait-expectancy system may choose when or if to go to an establishment by the use of data provided by the sensors. The sensors may be installed in chairs, booths, benches, flooring, and/or other suitable locations in order to determine a number of patrons present at any given time within the establishment.

Additionally, the wait-expectancy system may allow a business/establishment owner to know and manage how busy the establishment may be at any given time in order to maximize capacity. The wait-expectancy system may reduce waiting times, save customers/users commutes, and/or maximize the efficiency of establishments. The wait-expectancy system may be linked to a mobile application to allow an individual to view the data provided by sensors.

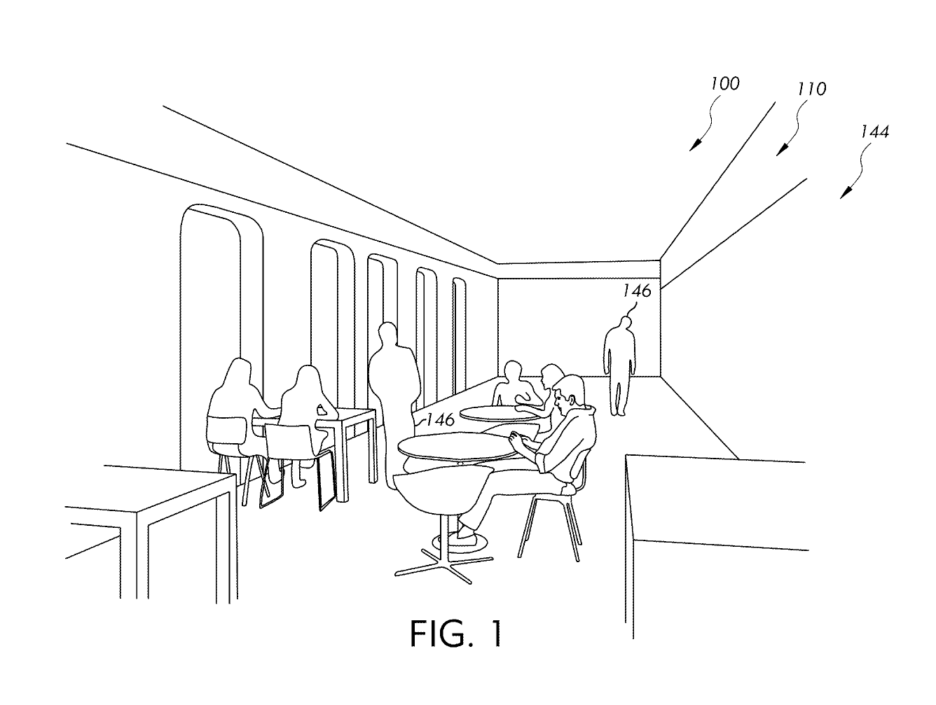

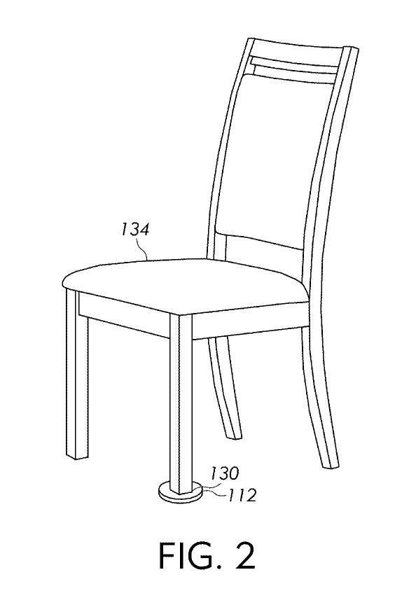

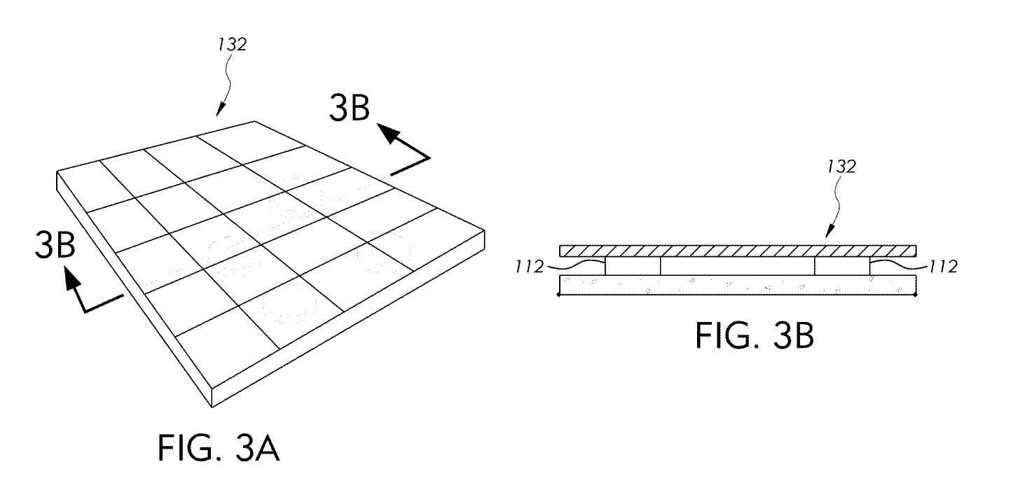

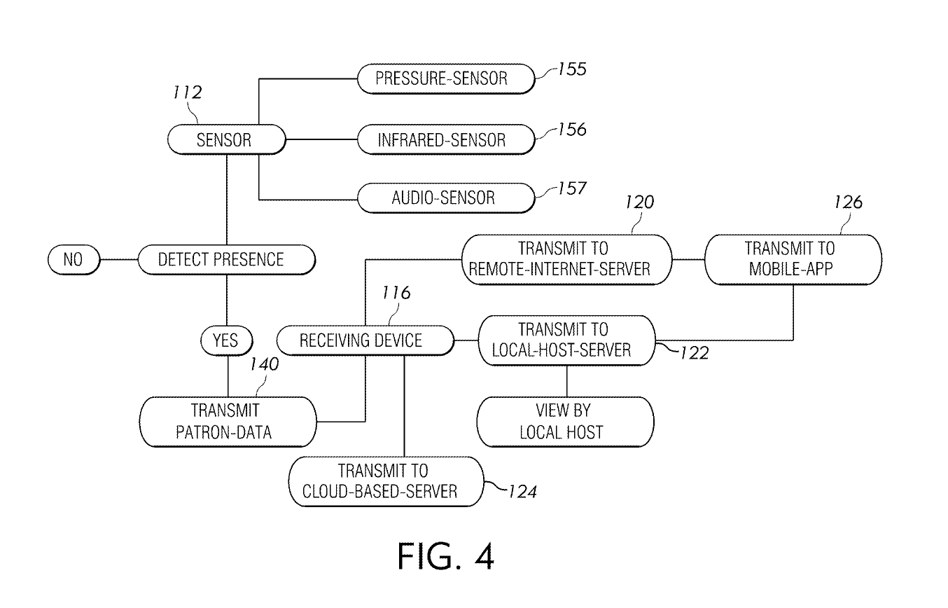

Referring now more specifically to the drawings by numerals of reference there is shown in FIGS. 1-4, various views of wait-expectancy system 100 comprising wait-expectancy assembly 110. Wait-expectancy assembly 110 may comprise a plurality of sensors 112 removably installed upon at least one surface 130 and receiving-device 116 in communication with the plurality of sensors 112.

Sensors 112 may be structured and arranged (configured) to provide patron-data 140, patron-data 140 including an indication of a number of patrons 146 present within establishment 144. Also, plurality of sensors 112 may transmit the patron-data 140 related to the indication of a number of patrons 146 to one or more receiving-device(s) 116, where patron-data 140 may be presented to a user such that the user may view and evaluate patron-data 140.

In some embodiments, the receiving-device 116 may include remote-internet-server 120. In other embodiments, the receiving-device 116 may include local-host-server 122. Further embodiments may include local-host-server 122 connectable to remote-internet-server 120. Embodiments of wait-expectancy system 100 may include patron-data 140 viewable by an employee of establishment 144 upon local-host-server 122, the employee of establishment 144 located within establishment 144 during viewing of patron-data 140.

The least one surface 130 upon which the plurality of sensors 112 may be removably installed upon may be floor 132 in some embodiments. Some embodiments may also (or additionally) include surface 130 upon which plurality of sensors 112 being seating-devices 134. Plurality of sensors 112 may include pressure-sensor(s) 155 to detect pressure upon at least one surface by one or more patrons 146, may include infrared-sensor(s) 156 to detect a heat-signature provided by one or more patrons 146, and/or may include audio-sensor(s) 157 to confirm a presence of one or more patrons 146 via sound. Plurality of sensors 112 may transmit patron-data 140 to a cloud-based-server 124 to record and store patron-data for future use 140. Placement of sensors 112 may vary as needed.

Embodiments of wait-expectancy 100 system may additionally include mobile-app 126 executable upon a mobile-device (e.g., mobile phone, tablet, laptop computer, etc.). Mobile-app 126 may provide patron-data 140 to the mobile-device accessible by the user. In some embodiments, mobile-app 140 may also provide alerts to the mobile-device (and subsequently the user) based on a predetermined number of patrons 146 present at establishment 144. Mobile-app 140 may further includes a map-module such that the user may view a location of establishment 144 in a map-view, and the map of mobile-app 140 may provides a visual indication of number of patrons 146 viewable upon the mobile-device related to the location of establishment 144.

Wait-expectancy system 100 may be structured and arranged to provide the user with an indication of a number of patrons 146 present within establishment 144 such that the user may postulate a wait time for customer-service within establishment 144 and make a decision whether or not to procure goods and/or services from establishment 144.

Wait-expectancy system 100 may be sold as a kit comprising the following parts: at least one wait-expectancy assembly 110 (comprising at least one sensors 112); at least one receiving-device 116 (in communication with sensor(s) 112); at least one mobile-app 126 (in communication with receiving-device 116); and at least one set of user instructions. The kit has instructions such that functional relationships are detailed in relation to the structure of the invention (such that the invention can be used, maintained, or the like in a preferred manner).

Wait-expectancy system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different application tangible functions and combinations, parts may be sold separately, etc., may be sufficient.

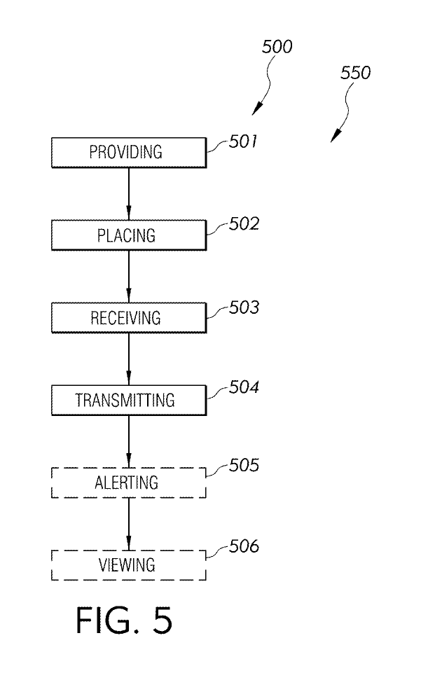

Referring now to FIG. 5 showing a flow diagram 550 illustrating method of use 500 for wait-expectancy system 100 according to an embodiment of the present invention of FIGS. 1-4. As shown, method of use 500 may comprise the steps of: step one 501, providing a wait-expectancy system 100 (comprising wait-expectancy assembly 110, wait-expectancy assembly 110 comprising sensors 112 removably installed upon surface 130, and receiving-device 116); step two 502, placing sensors 112 upon surface 130 to provide patron-data 140 to receiving-device 116; step three 503, receiving patron-data 140 upon receiving-device 116; step four 504, transmitting patron-data 140 to at least one user; step five 505, viewing patron-data 140; and step six 506, altering the user r based upon a predetermined condition of patron-data 140.

It should be noted that step five 505 and step six 506 are an optional steps and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wait-expectancy system comprising:
a wait-expectancy assembly comprising;
a plurality of sensors removably installed upon at least one surface; and
a receiving-device in communication with said plurality of sensors;
wherein said sensors are structured and arranged to provide patron-data, said patron-data including an indication of a number of patrons present within an establishment;
wherein said plurality of sensors transmit said patron-data related to said indication of a number of patrons to said receiving-device;
wherein said patron-data is presented to a user such that a user may view and evaluate said patron-data; and
wherein said wait-expectancy system is structured and arranged to provide said user with an indication of said number of patrons present within said establishment such that said user may postulate a wait time for customer-service within said establishment.

2. The wait-expectancy system of claim 1 wherein said receiving-device includes a remote-internet-server.

3. The wait-expectancy system of claim 1 wherein said receiving-device includes a local-host-server.

4. The wait-expectancy system of claim 3 wherein said local-host-server is connectable to a remote-internet-server.

5. The wait-expectancy system of claim 3 wherein said patron-data is viewable by an employee of said establishment upon said local-host-server, said employee of said establishment located within said establishment during viewing of said patron-data.

6. The wait-expectancy system of claim 1 wherein said at least one surface upon which said plurality of sensors is installed upon is a floor.

7. The wait-expectancy system of claim 1 wherein said at least one surface upon which said plurality of sensors is installed upon is a plurality of seating-devices.

8. The wait-expectancy system of claim 1 wherein said plurality of sensors includes pressure-sensors to detect pressure upon said at least one surface by one or more of said patrons.

9. The wait-expectancy system of claim 1 wherein said plurality of sensors include infrared-sensors to detect a heat-signature provided by one or more of said patrons.

10. The wait-expectancy system of claim 1 wherein said plurality of sensors include audio-sensors to confirm a presence of one or more of said patrons via sound.

11. The wait-expectancy system of claim 1 wherein said plurality of sensors transmit said patron-data to a cloud-based-server to record and store said patron-data for future use.

12. The wait-expectancy system of claim 1 wherein said wait expectancy system further includes a mobile-app executable upon a mobile-device.

13. The wait-expectancy system of claim 12 wherein said mobile-app provides said patron-data to said mobile-device accessible by said user.

14. The wait-expectancy system of claim 13 wherein said mobile-app provides alerts to said mobile-device and said user based on a predetermined number of said patrons present at said establishment.

15. The wait-expectancy system of claim 14 wherein said mobile-app further includes a map-module such that said user may view a location of said establishment in a map-view.

16. The wait-expectancy system of claim 15 wherein said map of said mobile-app provides a visual indication of number of said patrons viewable upon said mobile-device related to said location of said establishment.

17. A wait-expectancy system comprising:
a wait-expectancy assembly comprising;
a plurality of sensors removably installed upon at least one surface; and
a receiving-device in communication with said plurality of sensors;
wherein said sensors are structured and arranged to provide patron-data, said patron-data including an indication of a number of patrons present within an establishment;
wherein said plurality of sensors transmit said patron-data related to said indication of a number of patrons to said receiving-device;
wherein said patron-data is presented to a user such that a user may view and evaluate said patron-data;
wherein said wait-expectancy system is structured and arranged to provide said user with an indication of said number of patrons present within said establishment such that said user may postulate a wait time for customer-service within said establishment;
wherein said receiving-device includes a local-host-server;
wherein said local-host-server is connectable to a remote-internet-server;
wherein said patron-data is viewable by an employee of said establishment upon said local-host-server, said employee of said establishment located within said establishment during viewing of said patron-data;
wherein said at least one surface upon which said plurality of sensors is installed includes at least a floor and a plurality of seating-devices;
wherein said plurality of sensors further includes pressure-sensors to detect pressure upon said surface by one or more of said patrons;
wherein said plurality of sensors further includes infrared-sensors to detect a heat-signature provided by one or more of said patrons;
wherein said plurality of sensors further includes audio-sensors to confirm a presence of one or more of said patrons via sound.
wherein said plurality of sensors transmit said patron-data to a cloud-based-server to record and store said patron-data for future use;
wherein said wait expectancy system further includes a mobile-app executable upon a mobile-device;
wherein said mobile-app provides said patron-data to said mobile-device accessible by said user;
wherein said mobile-app provides alerts to said mobile-device and said user based on a predetermined number of said patrons present at said establishment;
wherein said mobile-app further includes a map-module such that said user may view a location of said establishment in a map-view; and
wherein said map of said mobile-app provides a visual indication of number of said patrons viewable upon said mobile-device related to said location of said establishment.

18. The wait-expectancy system of claim 17 further comprising a kit including:
said wait-expectancy assembly comprising;
said plurality of sensors removably installed upon said surface;
said receiving-device in communication with said plurality of sensors; and
said mobile-app in communication with said receiving-device.

19. A method of using a wait-expectancy system comprising the steps of:
providing a wait-expectancy system, said wait-expectancy system comprising;
a wait-expectancy assembly comprising;
a plurality of sensors removably installed upon at least one surface; and
a receiving-device;
placing said plurality of sensors removably installed upon said at least one surface to provide patron-data to said receiving-device;
receiving said patron-data upon said receiving-device; and
transmitting said patron-data to a user.

20. The method of claim 19 further comprising the steps of:
viewing said patron-data; and
altering a user based upon a predetermined condition of said patron-data.
